(19) United States
(12) Patent Application Publication
(10) Pub. No.: US 2011/0140757 A1
(43) Pub. Date: Jun. 16, 2011

(54) Analog Processing Elements In A Sum of Products

(75) Inventor: Andrew Martin Mallinson, Kelowna (CA)

(73) Assignee: ESS TECHNOLOGY, INC., FREMONT, CA (US)

(21) Appl. No.: 12/683,119

(22) Filed: Jan. 6, 2010

Related U.S. Application Data
(63) Continuation of application No. PCT/US10/20157, filed on Jan. 5, 2010.
(60) Provisional application No. 61/285,868, filed on Dec. 11, 2009.

(51) Int. Cl. G06G 7/16

(52) U.S. Cl. 327/356

(57) ABSTRACT

The technology relates to analog processing of a sum of products.

### REFERENCE TO RELATED APPLICATION

This application is a continuation of PCT Application No. PCT/US10/20157, filed 5 Jan. 2010 which claims the benefit of U.S. Provisional Application No. 61/285,868 filed 11 Dec. 2009, and this application claims the benefit of U.S. Provisional Application No. 61/285,868 filed 11 Dec. 2009, all of which are incorporated by reference herein.

### BACKGROUND OF THE INVENTION

The Digital Sampling Mixer (DSM) of the type described in the U.S. Pat. No. 7,028,070 and the FIR filter described in U.S. Pat. No. 6,035,320 are complex due to the relatively complicated multipliers and adder circuitry.

Furthermore, multipliers and adders are complex elements that generally contain active devices. Active devices create noise of various kinds and can limit the bandwidth of signal processing. Also, being active elements, the typical multiplier and adder circuit requires a power supply, and such a supply causes degradation due to a limited power supply rejection ratio. A finite power supply on an active element as is commonly used, also limits the signal amplitude that can pass though the system. Such a limitation places a lower limit on the signal to noise ratio.

### SUMMARY OF THE INVENTION

Various embodiments relate to analog processing of a sum of products.

One aspect of the technology is an apparatus including a plurality of multiplier circuits with a resistive network, as follows. The plurality of multiplier circuits generate a differential analog product output by performing multiplication of a differential analog input and a variable multi-bit digital input. The multiplier circuits of the plurality of multiplier circuits comprise a resistive network sufficient to (i) generate partial products by performing multiplication of the differential analog input with different bits of the variable multi-bit digital input and (ii) combine the partial products according to varying weights of the different bits of the variable multi-bit digital input. The differential analog product outputs from the plurality of multiplier circuits are summed, by parallel electrical connection of the differential analog product outputs.

In some embodiments, the differential analog product outputs from the plurality of multiplier circuits include first analog product outputs and second analog product outputs. The differential analog product outputs are the differences between the first analog product outputs and the second analog product outputs. The resistive networks in the plurality of multiplier circuits include first networks generating the first analog product outputs and second networks generating the second analog product outputs. The resistive networks of the plurality of multiplier circuits comprise sets of switches controlled by the multi-bit digital inputs.

In one embodiment, the sets of switches generate the partial products by electrically coupling the differential analog inputs to the first networks generating the first analog product outputs or to the second networks generating the second analog product outputs.

In one embodiment, positions in the resistive networks of switches in the sets of switches result in the varying weights of the partial products. In one embodiment, the sets of switches are positioned between first parts of the resistive networks corresponding to the partial products and second parts of the resistive networks corresponding to the varying weights of the partial products.

In some embodiments, the resistive networks include a number of copies of a cell of resistors and switches. The number of copies of the cell corresponds to a number of partial products in the multiplication. The copies of the cell are electrically connected in sequence.

In one embodiment, the differential analog input is supplied to the copies of the cells. Different bits of the variable multi-bit digital input are supplied to different copies of the cells. The different copies of the cells generate different partial products.

In one embodiment, positions of the cell in the sequence correspond to the varying weights of the partial products.

In one embodiment, the copies of the cell are electrically connected in sequence via a particular resistance in the cell. The electrically connected sequence of cells is terminated with twice the particular resistance in the cell.

Some embodiments further include sample and hold circuitry.

In one embodiment, the sample and hold circuitry provides finite impulse response filter inputs as the differential analog inputs to the plurality of multiplier circuits.

In one embodiment, the sample and hold circuitry provides digital sampling mixer inputs as the differential analog inputs to the plurality of multiplier circuits.

Another aspect of the technology is an apparatus including a plurality of multiplier circuits with a resistive network, as follows. The plurality of multiplier circuits generate a differential analog product output by performing multiplication of a differential analog input and a fixed multi-bit digital input. The multiplier circuits of the plurality of multiplier circuits comprise a resistive network sufficient to (i) generate partial products by performing multiplication of the differential analog input with different bits of the fixed multi-bit digital input and (ii) combine the partial products according to varying weights of the different bits of the fixed multi-bit digital input. The differential analog product outputs from the plurality of multiplier circuits are summed, by parallel electrical connection of the differential analog product outputs.

In one embodiment, the fixed multi-bit digital input is a fixed interconnection of resistors.

In some embodiments, the differential analog product outputs from the plurality of multiplier circuits include first analog product outputs and second analog product outputs. The differential analog product outputs are the differences between the first analog product outputs and the second analog product outputs. The resistive networks include first networks generating the first analog product outputs and second networks generating the second analog product outputs. The partial products are electrically coupled to the first networks or to the second networks according to the fixed multi-bit digital inputs of the plurality of multiplier circuits.

In some embodiments, the resistive networks include a number of copies of a cell of resistors. The number of copies of the cell corresponds to a number of partial products in the multiplication. The copies of the cell are electrically connected in sequence.

In one embodiment, the differential analog input is supplied to the copies of the cells. Different bits of the fixed multi-bit digital input are supplied to different copies of the cells. The different copies of the cells generate different partial products.

In one embodiment, positions of the cell in the sequence corresponding to the varying weights of the partial products.

In one embodiment, the copies of the cell are electrically connected in sequence via a particular resistance in the cell. The electrically connected sequence of cells is terminated with twice the particular resistance in the cell.

Some embodiments further include sample and hold circuitry.

In one embodiment, the sample and hold circuitry provides finite impulse response filter inputs as the differential analog inputs to the plurality of multiplier circuits.

In one embodiment, the sample and hold circuitry provides digital sampling mixer inputs as the differential analog inputs to the plurality of multiplier circuits.

Another aspect of the technology is an apparatus including a plurality of multiplier circuits with a resistive network, as follows. The plurality of multiplier circuits generate a single-ended analog product output by performing multiplication of a differential analog input and a variable multi-bit digital input. The multiplier circuits of the plurality of multiplier circuits comprise a resistive network sufficient to (i) generate partial products by performing multiplication of the differential analog input with different bits of the variable multi-bit digital input and (ii) combine the partial products according to varying weights of the different bits of the variable multi-bit digital input. The single-ended analog product outputs from the plurality of multiplier circuits are summed, by parallel electrical connection of the single-ended analog product outputs.

In some embodiments, the single-ended analog product outputs from the plurality of multiplier circuits include first analog product outputs. The single-ended analog product outputs are the first analog product outputs. The resistive networks in the plurality of multiplier circuits includes first networks generating the first analog product outputs. The resistive networks of the plurality of multiplier circuits comprise sets of switches controlled by the multi-bit digital inputs with bits having a first value or a second value.

In one embodiment, the sets of switches generate the partial products corresponding to the bits having the first value (e.g., ‘1’) by electrically coupling the differential analog inputs to the first networks generating the first analog product outputs.

In one embodiment, positions in the resistive networks of switches in the sets of switches result in the varying weights of the partial products. In one embodiment, the sets of switches are positioned between first parts of the resistive networks corresponding to the partial products and second parts of the resistive networks corresponding to the varying weights of the partial products.

In some embodiments, the resistive networks include a number of copies of a cell of resistors and switches. The number of copies of the cell corresponds to a number of partial products in the multiplication. The copies of the cell are electrically connected in sequence.

In one embodiment, the differential analog input is supplied to the copies of the cells. Different bits of the variable multi-bit digital input supplied to different copies of the cells. The different copies of the cells generate different partial products.

In one embodiment, positions of the cell in the sequence corresponding to the varying weights of the partial products.

In one embodiment, the copies of the cell being electrically connected in sequence via a particular resistance in the cell. The electrically connected sequence of cells is terminated with twice the particular resistance in the cell.

Some embodiments further include sample and hold circuitry.

In one embodiment, the sample and hold circuitry provides finite impulse response filter inputs as the differential analog inputs to the plurality of multiplier circuits.

In one embodiment, the sample and hold circuitry provides digital sampling mixer inputs as the differential analog inputs to the plurality of multiplier circuits.

Another aspect of the technology is an apparatus, including a plurality of multiplier circuits with a resistive network, as follows. The plurality of multiplier circuits generate a single-ended analog product output by performing multiplication of a differential analog input and a fixed multi-bit digital input. The multiplier circuits of the plurality of multiplier circuits comprise a resistive network sufficient to (i) generate partial products by performing multiplication of the differential analog input with different bits of the fixed multi-bit digital input and (ii) combine the partial products according to varying weights of the different bits of the fixed multi-bit digital input. The single-ended analog product outputs from the plurality of multiplier circuits are summed, by parallel electrical connection of the single-ended analog product outputs.

In one embodiment, the fixed multi-bit digital inputs of the plurality of multiplier circuits are fixed interconnections of resistors.

In some embodiments, the single-ended analog product outputs from the plurality of multiplier circuits include first analog product outputs. The single-ended analog product outputs are the first analog product outputs. The resistive networks in the plurality of multiplier circuits include first networks generating the first analog product outputs. The partial products corresponding to bits of the fixed multi-bit digital input having a first value (e.g., ‘1’) are electrically coupled to the first networks.

In some embodiments, the resistive networks include a number of copies of a cell of resistors. The number of copies of the cell corresponds to a number of partial products in the multiplication corresponding to bits of the fixed multi-bit digital input having a first value. The copies of the cell being electrically connected in sequence.

In one embodiment, the differential analog input is supplied to the copies of the cells. Different bits of the fixed multi-bit digital input are supplied to different copies of the cells. The different copies of the cells generate different partial products.

In one embodiment, positions of the cell in the sequence corresponding to the varying weights of the partial products.

In one embodiment, the copies of the cell being electrically connected in sequence via a particular resistance in the cell. The electrically connected sequence of cells is terminated with twice the particular resistance in the cell.

Some embodiments further include sample and hold circuitry.

In one embodiment, the sample and hold circuitry provides finite impulse response filter inputs as the differential analog inputs to the plurality of multiplier circuits.

In one embodiment, the sample and hold circuitry provides digital sampling mixer inputs as the differential analog inputs to the plurality of multiplier circuits.

Other embodiments are directed to methods.

### BRIEF DESCRIPTION OF THE DRAWINGS

FIG. 1 shows a circuit diagram of an R-2R DAC with a differential input voltage.

FIG. 2 shows a table of voltages on the output selectable from a multi-bit digital input.

FIG. 3 shows a circuit diagram of multiple R-2R DACs with anti-phase switches, a differential input voltage, and a differential output voltage.

FIG. 4 shows a circuit diagram of differential output voltage R-2R DACs, with outputs connected in parallel.

FIG. 5 shows a circuit diagram of differential output voltage R-2R circuits replacing DACs with fixed multi-bit digital coefficients, with outputs connected in parallel.

FIG. 6 shows a circuit diagram of differential output voltage R-2R DACs, with outputs connected in parallel, and switches connected between the 2R resistors and the R resistors.

FIG. 7 shows a circuit diagram of multiple instances of the differential output voltage R-2R DACs of FIG. 6, with the outputs connected in parallel.

FIG. 8 shows a circuit diagram of a reversing switch.

FIG. 9 shows a circuit diagram of a circuit symbol of the reversing switch of FIG. 8.

FIG. 10 shows a circuit diagram of a cell of a DAC with a reversing switch and resistors.

FIG. 11 shows a circuit diagram of multiple instances of the cell of a DAC shown in FIG. 10, capable of multiplying a multiplicand on S with a differential analog input signal on A.

FIG. 12 shows a circuit diagram of multiple instances of the cell of a DAC multiplier shown in FIG. 11, capable of performing a sum of products.

FIG. 13 shows a formula of the sum of products performed by the circuit of FIG. 12.

FIG. 14 shows a circuit diagram of a digital sampling mixer with the improved sum of products circuit of the present technology.

FIG. 15 shows a circuit diagram of a finite impulse response filter with the improved sum of products circuit of the present technology.

### DETAILED DESCRIPTION

Aspects of the technology relate to implementing an electronic analog sum-of-products device. Resistors and transmission gates are sufficient to implement the device.

In some embodiments, a multiplication and addition is accomplished with only passive devices (resistors) and possibly switches. In one embodiment no active devices are in the signal path, excepting the switches which approximate resistances, and no noise is introduced by any active devices. Furthermore, there is no power supply to limit the signal level and noise can therefore be optimized by use of a large signal.

The present technology is a significant improvement upon the FIR filter and Digital Sampling Mixer, as well as any circuit with a sum of products architecture. In embodiments of the technology, multiplication and summation are achieved with the use of resistors and without requiring active devices. The resistor connectivity is a DAC (Digital to Analog Converter) at each tap point, and the DAC networks so connected are themselves interconnected to form an addition to a specified output node. The multiplicand is expressed as a quantized quantity in the interconnection of resistors per tap; the multiplier is an analog quantity applied to the resistors at the tap point; and the output is an analog quantity present at a specified output node in the overall network. Some embodiments have transmission gates and the embedded multiplicand is dynamically altered either at run time in certain ‘rotating coefficient’ FIR filters, or at configuration time to adjust the frequency domain shaping of pipeline based analog FIR filters.

A sum-of-products circuit is useful in signal processing systems. For example, a FIR (Finite Impulse Response) filter is a sum of products, as is a neural network node, the elements of the DSM, or any other form of weighted average.

The sum-of-products “y” may be expressed as a sum over an index i from 1 to N, of the product xᵢ×wᵢ: where ‘x’ is a finite set of input parameters, and ‘w’ a finite set of weights, each of cardinality ‘N’. Each element of the set ‘x’ is multiplied by the corresponding element of the set ‘w’ and the results are summed to create a single output parameter ‘y’. The technology described herein relates to the use of analog circuits to perform the sum of products.

In an analog implementation the set of quantities ‘x’ are analog and hence are continuously variable (not quantized); the set of variables ‘w’ may be discrete or analog; and the output quantity ‘y’ is analog. In an FIR application embodiment, U.S. Pat. No. 4,120,035 is modified with the technology described herein, such that the analog quantity ‘x’ is stored in a charge coupled device, a discrete quantity ‘w’ is a set of digital coefficients, and an analog multiplier and summation circuit described herein is used to form the sum of products. In another FIR application embodiment, the FIR architecture of U.S. Pat. Nos. 4,475,170 and 6,035,320 has an analog FIR filter modified to omit a pipeline of analog samples, and instead use a ‘round-robin’ form of sample and hold with rotating (or otherwise dynamically selectable) coefficients using the technology described herein. The technology described herein replaces the coefficients (annotated as Cn), the switches (for example ‘24’), and the multiplier (for example, ‘14’) in U.S. Pat. No. 6,035,320. No selection mechanism is necessary, nor is a separate coefficient and multiplier. Resistors and transmission gate switches are sufficient for this embodiment; such resistors are inherently linear.

### First Circuit Example using R-2R DACs

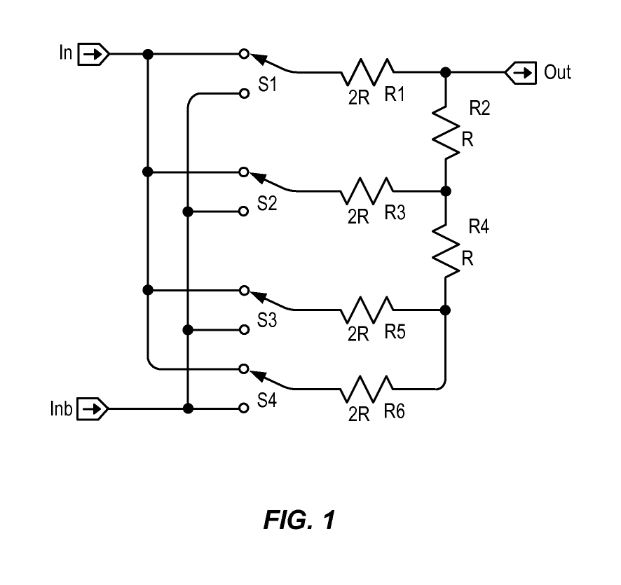

An example of a DAC at the tap point is a voltage mode R-2R DAC. The voltage mode R-2R DAC can use differential input. FIG. 1 shows the R-2R DAC with a differential input voltage signal applied between “In” and “Inb”. By setting the code on the four switches this DAC sets the voltage on the output terminal somewhere between the positive input voltage (the voltage on ‘In’) and the negative input voltages (the voltage on ‘Inb’).

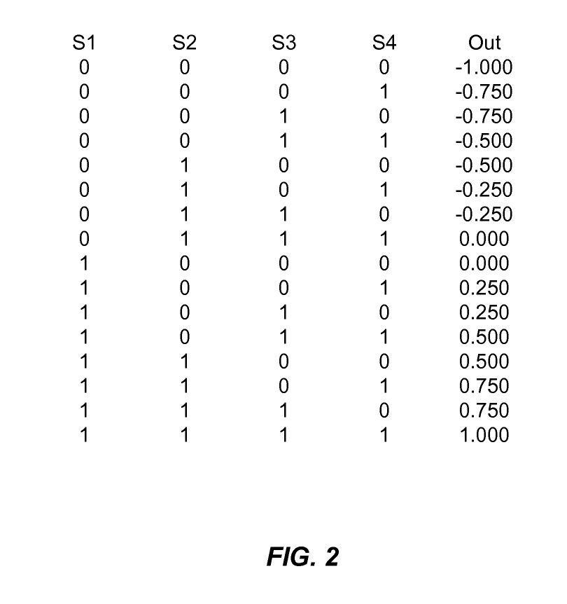

The complete set of voltages selectable on the output is shown in FIG. 2 when the voltage on ‘In’ is 1 and the voltage on ‘Inb’ is −1. There are nine possible output voltages equally spaced from −1 to 1. If the input code is 0111 or 1000 the output voltage is zero. This is multiplication: the setting of the switches causes the output to go from the input voltage to minus the input voltage.

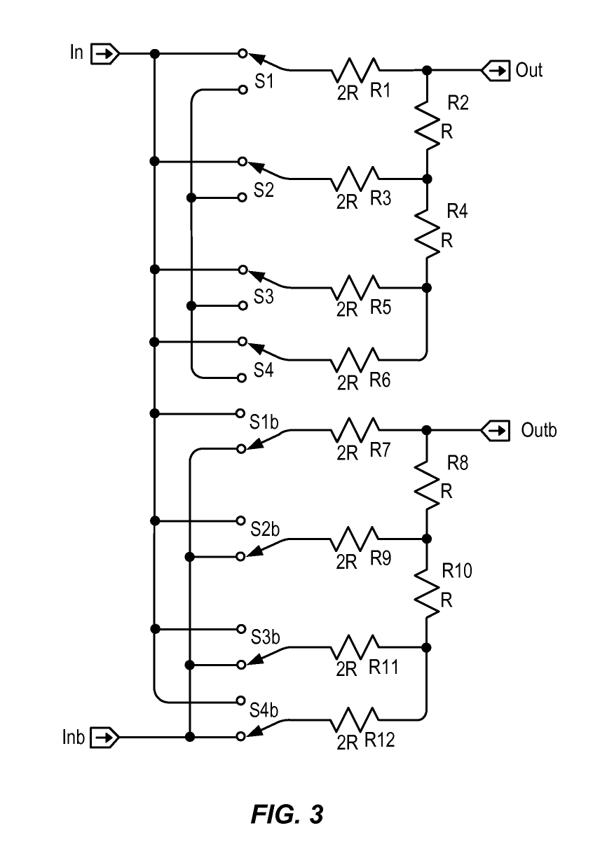

The output in this case is a voltage relative to ground. Some embodiments have an output quantity as a difference between node voltages. FIG. 3 adds a second R-2R DAC operating with anti-phase switches. The output quantity is the voltage difference between ‘Out’ and ‘Outb’. Since the switches operate in complementary fashion (i.e. if S1 is ‘1’ then S1b is ‘0’ and similarly for S2, S3, and S4), the output is one of nine possibilities between one times the input voltage difference and minus one times the input voltage difference. This is a multiplier whose multiplicand is the setting of the switches and whose multiplier is the input voltage difference. R-2R DAC's operate in anti-phase so as to create a differential output. Considering the digital switch setting to be the parameter W, and the input voltage difference to be X, Y (the output) is X*W as expected.

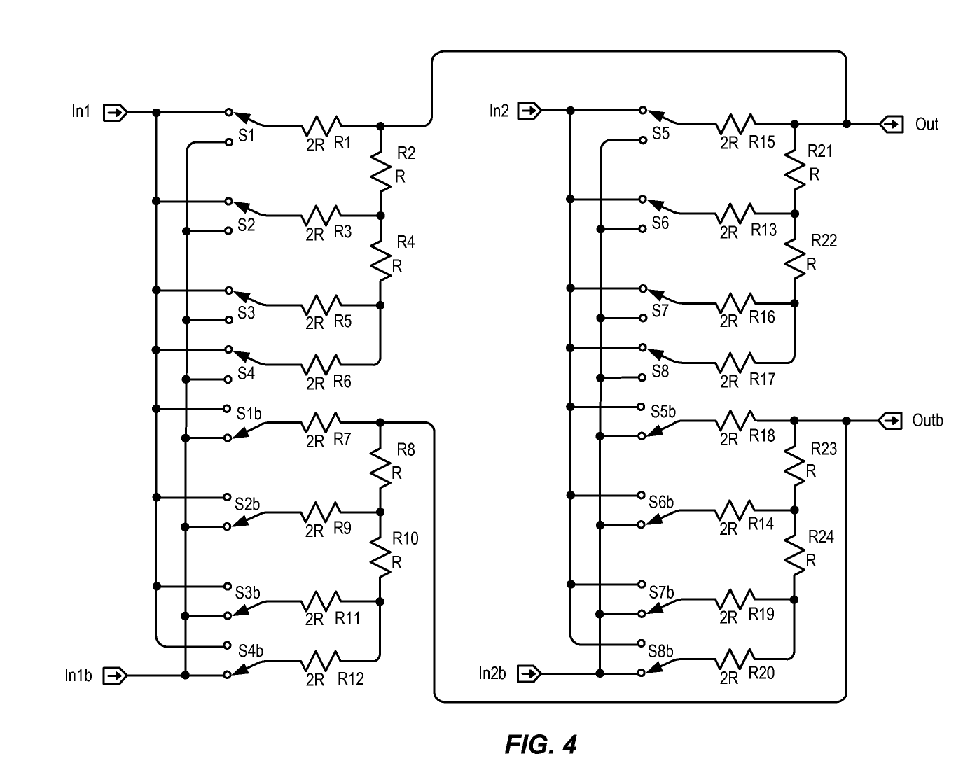

The R-2R DAC has constant output impedance of R. In FIG. 4 a number of the circuits are connected with the outputs in parallel.

Using X1 as the input voltage between In1 and In1b, X2 as the voltage input between In2 and In2b, W1 as the setting on the switches S1 through S4 and W2 as the setting on the switches S5 through S8, then Y=(X1*W1+X2*W2)/2. Achieved is the sum of two products with this network.

A differential DAC network per tap implements the multiplication and a common connection with known impedances implements a summation.

The Circuit Need not Use a DAC

One embodiment removes the DAC. It is not a DAC if there is no digital input. It is also not a DAC if the arrangement of resistors or the switches is not one of the known forms of analog to digital converter. Another embodiment has a circuit with a novel R-2R DAC.

Removing the DAC

The DAC of FIG. 4 can be adjusted during the operation of the sum-of-products circuits and consequently change the coefficient values (the ‘w’ values) ‘on the fly’ that is, at run time.

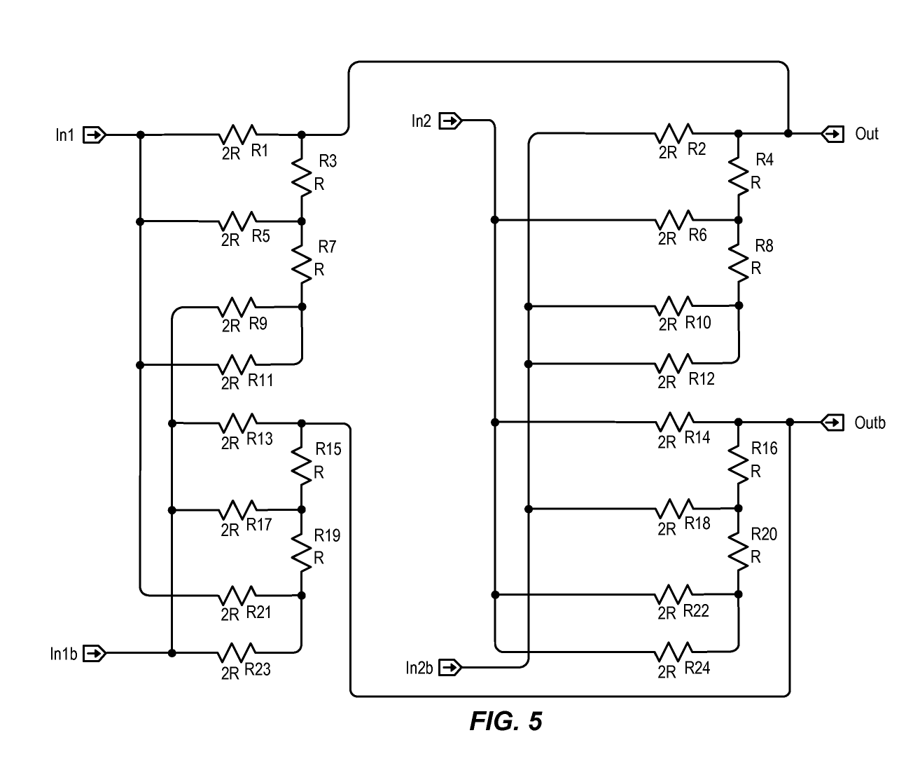

However, in other embodiments, the coefficients will not be changed and in these cases the circuit of FIG. 5 implements the technology:

Relative to FIG. 4, FIG. 5 hard-wires the code 1101 on what was the In1 DAC and 0100 on what was the In2 DAC. Consequently, applying the table of FIG. 2, the output of this circuit is Y=(X1*0.75−X2*0.5)/2.

Example with a Novel R-2R DAC

The circuit of FIG. 4 has the switch at the input terminals. This switch presents a capacitive load to the driver.

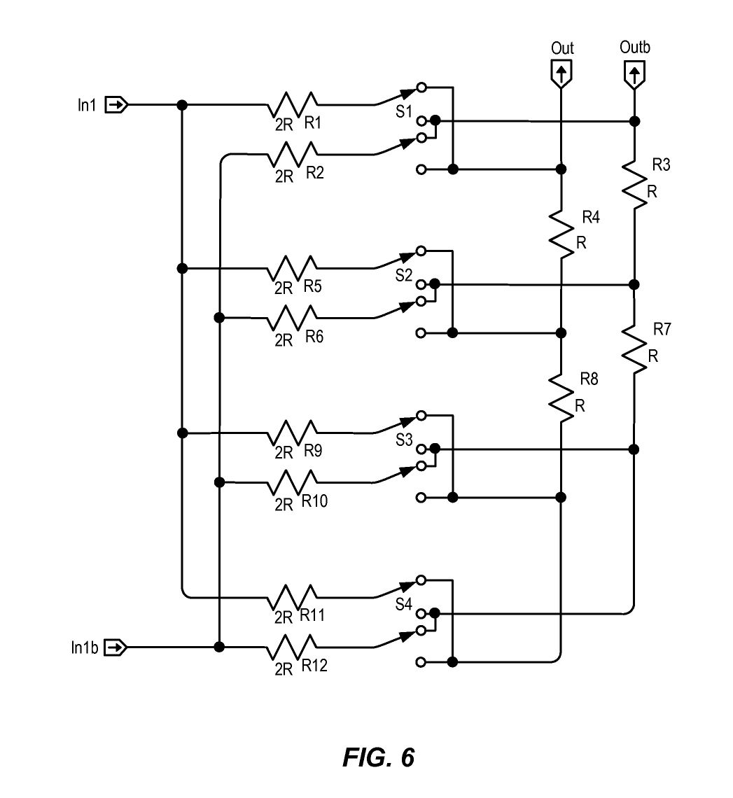

The circuit of FIG. 6 shows how the switches may be connected to the ‘other end’ of the 2R resistors, where the switch no longer presents a capacitive load. FIG. 6 clarifies that the switches operate in DPDT (Double Pole Double Throw) configuration. FIG. 6 shows one of the resistor networks associated with one of the tap points (one of the input parameters ‘x’). The summation is accomplished with a number of these circuits having separate inputs and common outputs. Such a circuit is used in the Syntony™ range of tuner circuits as part of the Digital Sampling Mixer.

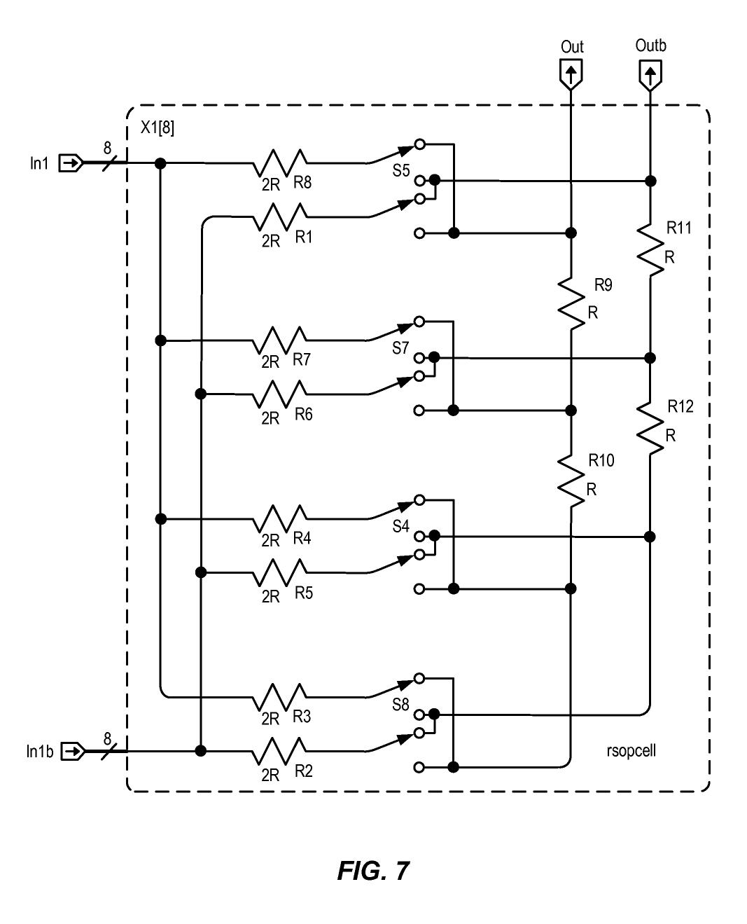

FIG. 7 shows how, for example, eight of the FIG. 6 circuits are connected to make the sum of eight products. FIG. 7 shows the components of FIG. 6 replicated eight times (within the annotation X1 [8] meaning eight repetitions). One wire emerges for each of ‘Out’ and ‘Outb’ so they are connected in common. Eight wires emerge for each of ‘In’ and ‘Inb’ so they separately make up eight differential inputs.

Example of a 10 Bit Control Number and 100 Tap Points

Making use of an iterated schematic, the following is a complete example of a sum of products circuit that uses ten digital control bits for the multiplicand and provides a sum of products over one hundred ‘x’ inputs.

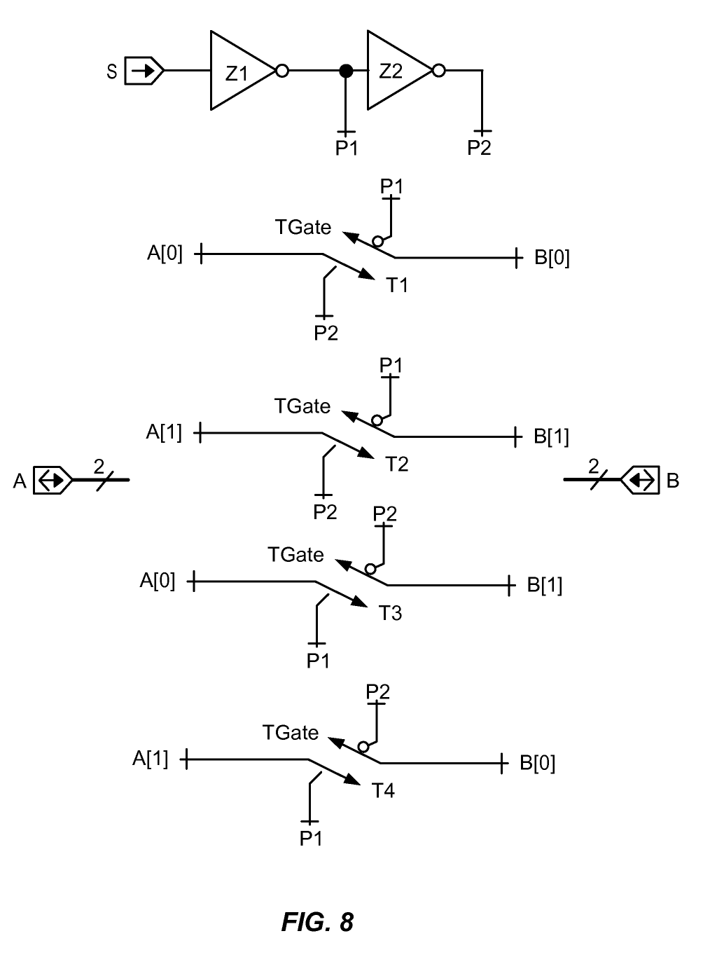

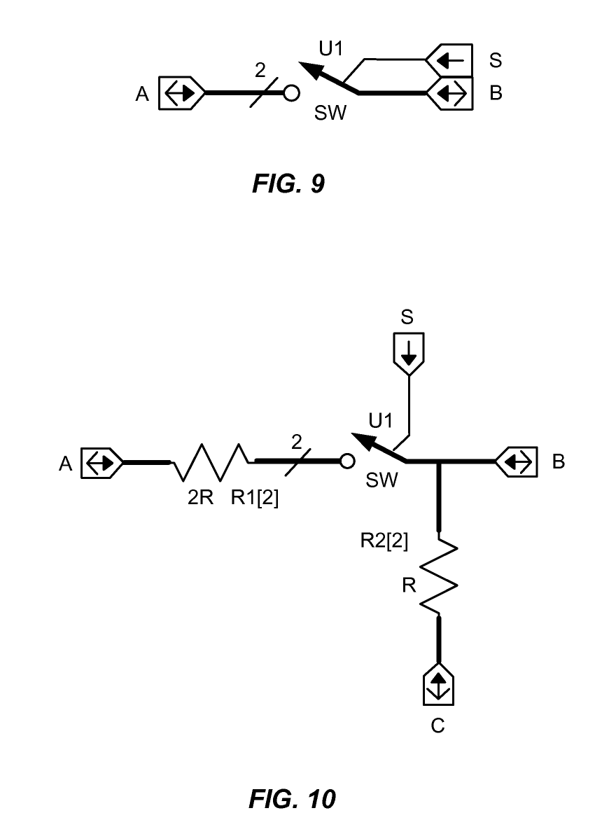

The circuit of FIG. 8 shows a reversing switch, a control input ‘S’ and two IO buses each of 2 bits, named ‘A’ and ‘B’. The transmission gates (labeled Tn) are ‘on’ (that is low resistance) when the wire connecting the bubble input (the top input) is low and the wire connecting the bottom input is high. Consequently, if ‘S’ is high then P1 will be low and P2 will be high (from the use of the inverters Z1 and Z2). In this case T1 and T2 will be ‘on’ and T3 and T4 will be ‘off’. When S is high the connection is from A[0] to B[0] and A[1] to B[1]. Conversely, when ‘S’ is low T3 and T4 are ‘on’ and T1 and T2 are ‘off’, so the connection is from A[0] to B[1] and from A[1] to B[0]. This then is a reversing switch: when S is low the connections from A to B are swapped, when S is high the connections from A to B are direct. This circuit is represented in the icon of FIG. 9. The buses A and B are two elements wide and S is one element wide. The elemental part of the DAC section uses iterated instances as in FIG. 10.

Two resistors are used (for example R1 [2] connected on a two bit bus—in these cases each resistor connects to each element of the bus). These components are wrapped into an icon and connected to make a ten bit digital multiplicand—equivalently a ten bit DAC.

To illustrate the rule for connections from busses to instances, the 2-bit wide A bus has 2R R1[2]. This makes the following SPICE netlist:

R1 B[0] A[0] 1000.0

R1_{—}1 B[1] A[1] 1000.0

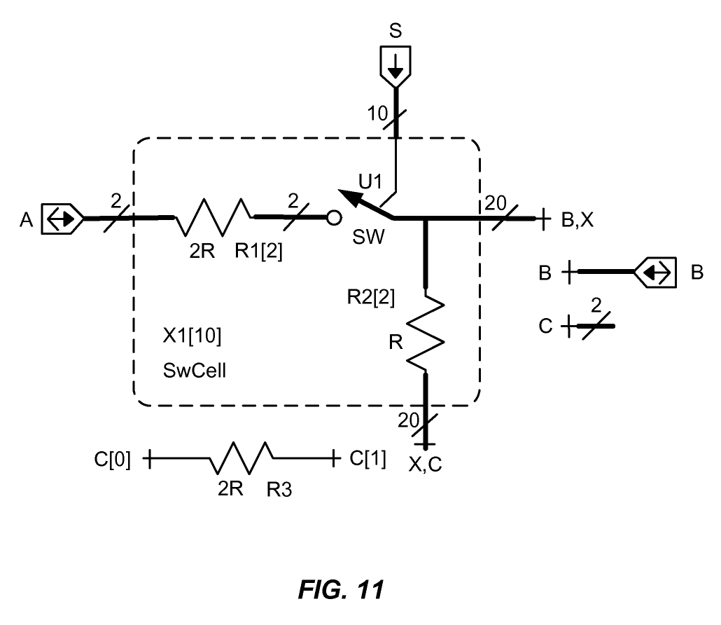

In FIG. 11, the elements of the switch and resistors in the outline are a transparent icon that collects the components together and is named ‘SwCell’ and is iterated ten times (the name X1 [10] shows this). Because only two wires are in the bus ‘A’ connected to the two wires of the internal bus, each element of ‘A’ connects to all ten instances. Contrast the bus ‘S’: here a bus of ten wires connects to the ten instances of SwCell which has an internal bus one wire wide, hence in this case all 10 elements of the S bus connect individually to the ten instances of SwCell. Note the 20 element bus notated as ‘B,X’. This being 20 elements wide and connecting to ten buses each two elements wide, connecting every instance separately. Further, the notation ‘B,X’ indicates that the elements of this 20 element bus are named as ‘B’ up at the MSB end and ‘X’ at the LSB end. ‘B’ is a bus of two elements and ‘X’ not appearing on any wire on its own has the remaining width. The schematic therefore uses first the two elements of ‘B’ as the MSB and Next MSB and takes 18 elements of X to make the remaining wires of the 20 bit bus. Finally, note the bus of 20 elements emerging at the bottom and connected to ‘X,C’. ‘C’ is notated as 2 bits wide (on a short segment to the right of the grey outline) and the bus ‘X’ has the remaining width. Consequently the schematic uses C as the two low bits LSB and NLSB and uses 18 elements from ‘X’ to fill in the MSB's.

The resistor R2 within the SwCell is connected in series: in the zero'th instance of SwCell the bottom of the two resistors R2 connect to the bus ‘C’; the tops connect to X[0] and X[1]. X[0] and X[1] then connect to the bottom of the R2 resistors in the 1'st instance of SwCell; the tops emerge on X[3] and X[2] and connect to the bottom of the 2'nd instance and so forth. Until finally, in the 9'th instance the tops emerge on the wires B[1] and B[0]. Thus the resistors R2 are connected in series throughout the ten instances of SwCell (the ten instances are 0, 1,2,3 . . . 7,8,9). Resistors which are connected to the resistive network that emerges on wire B[1] can be considered one resistive network, and resistors which are connected to the resistive network that emerges on wire B[0] can be considered another resistive network

So FIG. 11 represents one ten element resistor group capable of applying a ten bit multiplicand (on the bus ‘S’) to the analog signal applied between A[1] and A[0]. Note also the termination resistor R3 of value 2R: this connects between the LSB resistors R2 of the zero'th cell. This terminates the impedances (and corresponds to the resistor R6 in FIG. 1.)

Having developed this methodology of iterated instances, transparent icons and bus naming, the following discusses the complete 100 term sum of products:

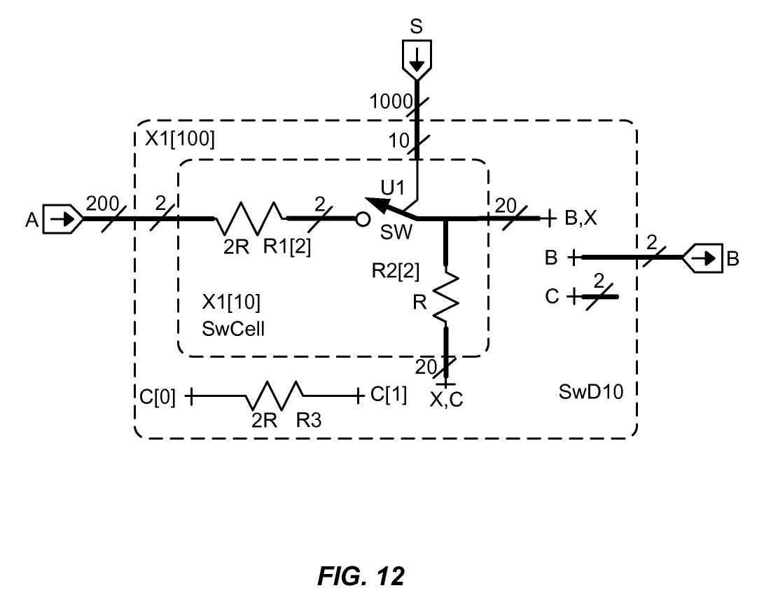

In FIG. 12, the icon SwD10 contains the ten elements that make up the multiplicand. This icon is itself iterated 100 times and consequently contains 1000 repetitions of the SwCell contents. The bus A enters the iterated instance with 200 wires so connecting one-to-one to the 200 wires inside. ‘A’ therefore forms 100 differential inputs between which the quantities ‘x’ are applied. The bus S enters with 1000 wires and connects one-to-one to the internal 1000 wires. S is therefore a bus of 100×10 bit words representing the 100 multiplicands. The bus B is two wires and so connects to every SwD10 in parallel, forming the summation of the outputs.

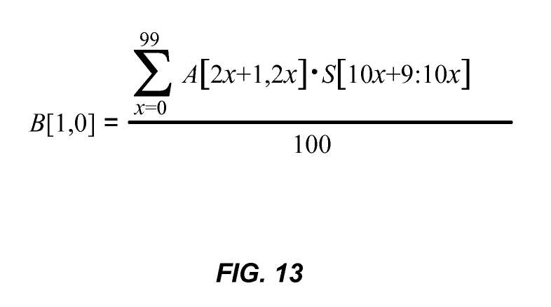

FIG. 12 shows a complete 100 element sum of products circuit. The analog quantity expressed as a voltage difference between A[1] and A[0] is multiplied by the digital quantity expressed on the bits of S between 9 and 0 (i.e. S[9:0]) and added to the voltage expressed between A[3] and A[2] multiplied by S[19:10], etc. Using the nomenclature A[6,5] to mean the voltage between A[6] and A[5] and S[39:30] as the digital word on the bits S[30] through S[39] the output is expressed in FIG. 13.

In FIG. 13, B[1,0] is the output voltage between B[1] and B[0]. Note the scaling factor of 100. Ideally, the scaling factor should be 1 to be just the sum of the products. Because the outputs are resistively added, the scaling factor 100 reduces the amplitude of the result.

### Digital Sampling Mixer Embodiment

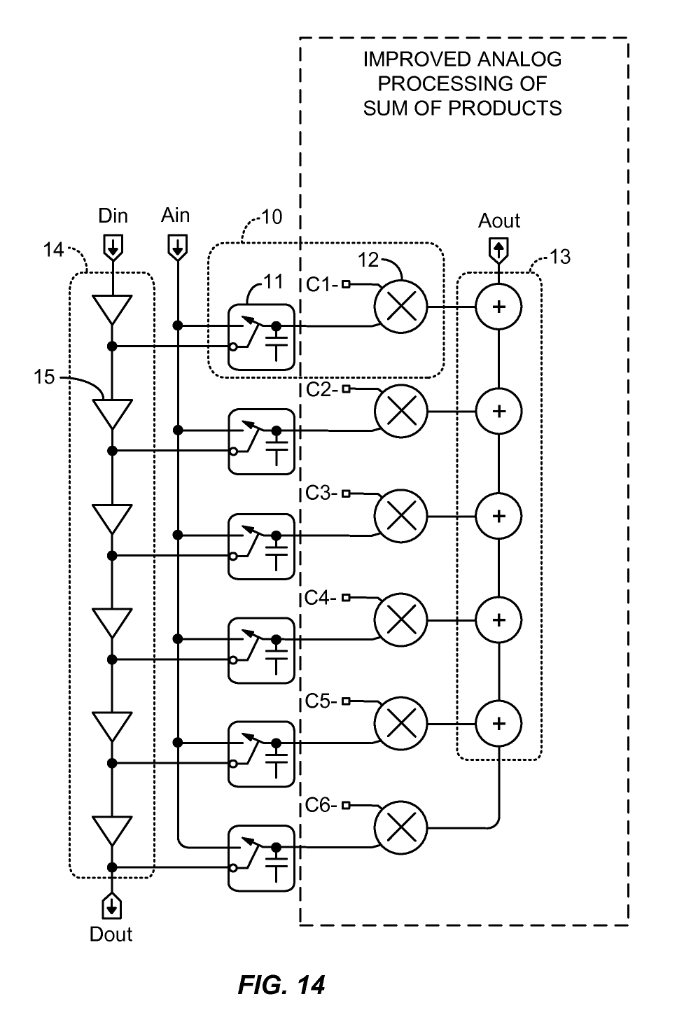

One embodiment is an improvement of the digital sampling mixer of U.S. Pat. No. 7,028,070, incorporated by reference herein, enhanced with the use of the sum-of-products circuit described herein. In FIG. 14, the output from the sample and hold 11 connects to the A[1,0] input of the sum-of-products circuit described herein, and successive sample and hold outputs to successive A inputs. The coefficients ‘C’ are the digital words on the ‘S’ bus described herein, and the output ‘Aout’ is replaced with the voltage between B[1] and B[0] on the B bus described herein.

This DSM [digital sampling mixer] is an example of where the digital bus ‘S’ is set one time during configuration (configuration time') and thereafter held constant.

### FIR Embodiment

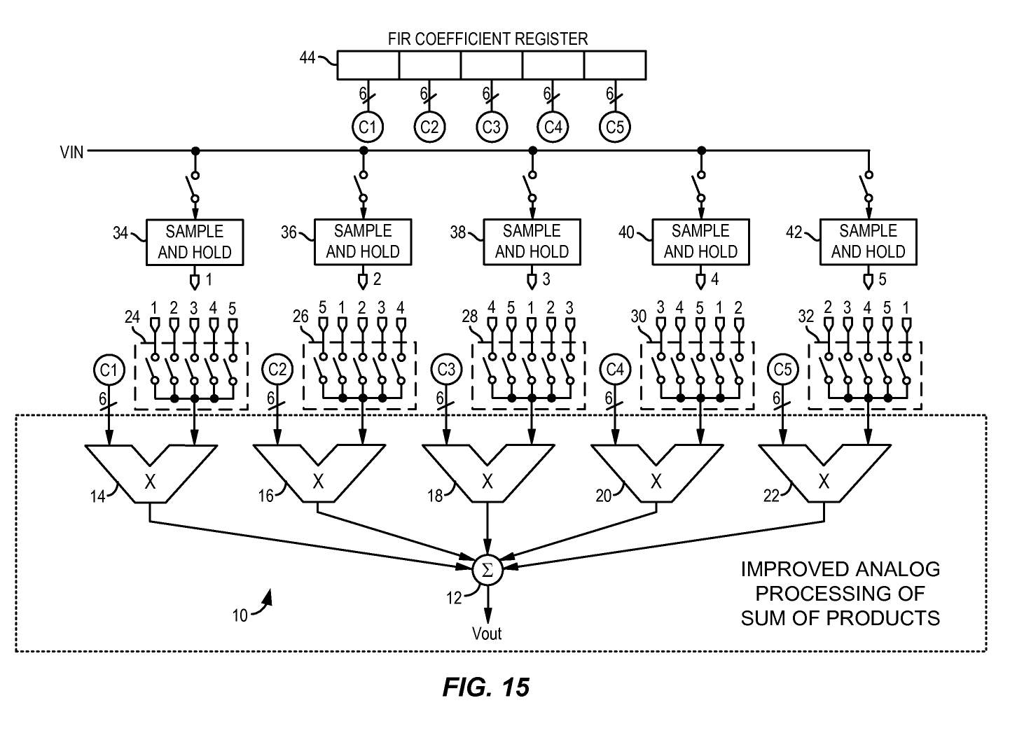

One embodiment is an improvement of the FIR filter of U.S. Pat. No. 6,035,320, incorporated by reference herein, showing the use of a sum-of-products and exemplifying the present technology's use of a multiplexer or similar circuit at the input to each multiplier, allowing the use of a ‘round robin’ sample and hold array rather than a pipeline of analog sample and holds. In the circuit of FIG. 15, the sum of products for a FIR filter is realized by selecting the appropriate ‘x’ value (the ‘x’ in this example at the outputs of the sample and holds) at the input to the multiplier with a specific coefficient. A fixed ‘x’ input and selected coefficient could be used. In that case this technology applies directly: the A inputs are connected to the sample and hold outputs, and the coefficients are driven onto the ‘S’ bus. Selection of coefficients is accomplished by changing the data on the ‘S’ bus, so selecting a different coefficient, such that the expected FIR characteristic arises. (Such selection is actually rotation of the coefficient values). This filter is an example where the digital bus ‘S’ is changed as the device is in operation (changed at ‘run time’) in order to produce the correct performance.

### Single-Ended Output Embodiment

To generate the single-ended output embodiment from the differential output embodiment, switches and resistors associated with In1b and OutB are deleted, such that partial products corresponding to a ‘0’ input bit in the multi-bit digital input, are never created, and partial products corresponding to a ‘1’ input bit in the multi-bit digital input, are created. In some embodiments, rather than deleting the switches, the switches become single-pole to discard partial products associated with the Outb output. In some embodiments, partial products corresponding to a ‘0’ input bit in the multi-bit digital input, are created (therefore preserving resistors of the differential embodiment) but the partial products are discarded.

1. An apparatus, comprising:
a plurality of multiplier circuits generating a differential analog product output by performing multiplication of a differential analog input and a variable multi-bit digital input, the multiplier circuits of the plurality of multiplier circuits comprising:
a resistive network sufficient to (i) generate partial products by performing multiplication of the differential analog input with different bits of the variable multi-bit digital input and (ii) combine the partial products according to varying weights of the different bits of the variable multi-bit digital input,
wherein the differential analog product outputs from the plurality of multiplier circuits are summed, by parallel electrical connection of the differential analog product outputs.

2. The apparatus of claim 1,
wherein the differential analog product outputs from the plurality of multiplier circuits include first analog product outputs and second analog product outputs, the differential analog product outputs being the differences between the first analog product outputs and the second analog product outputs,
wherein the resistive networks in the plurality of multiplier circuits includes first networks generating the first analog product outputs and second networks generating the second analog product outputs, and
wherein the resistive networks of the plurality of multiplier circuits comprise:
sets of switches controlled by the multi-bit digital inputs, the sets of switches generating the partial products by electrically coupling the differential analog inputs to the first networks generating the first analog product outputs or to the second networks generating the second analog product outputs.

3. The apparatus of claim 1,
wherein the differential analog product outputs from the plurality of multiplier circuits include first analog product outputs and second analog product outputs, the differential analog product outputs being the differences between the first analog product outputs and the second analog product outputs,
wherein the resistive networks in the plurality of multiplier circuits includes first networks generating the first analog product outputs and second networks generating the second analog product outputs, and
wherein the resistive networks of the plurality of multiplier circuits comprise:
sets of switches controlled by the multi-bit digital inputs, wherein positions in the resistive networks of switches in the sets of switches result in the varying weights of the partial products.

4. The apparatus of claim 1,
wherein the differential analog product outputs from the plurality of multiplier circuits include first analog product outputs and second analog product outputs, the differential analog product outputs being the differences between the first analog product outputs and the second analog product outputs,
wherein the resistive networks in the plurality of multiplier circuits includes first networks generating the first analog product outputs and second networks generating the second analog product outputs, and
wherein the resistive networks of the plurality of multiplier circuits comprise:
sets of switches controlled by the multi-bit digital inputs, the sets of switches generating the partial products by electrically coupling the differential analog inputs to the first networks generating the first analog product outputs or to the second networks generating the second analog product outputs, and wherein positions in the resistive networks of switches in the sets of switches result in the varying weights of the partial products, and wherein the sets of switches are positioned between first parts of the resistive networks corresponding to the partial products and second parts of the resistive networks corresponding to the varying weights of the partial products.

5. The apparatus of claim 1,
wherein the resistive networks include a number of copies of a cell of resistors and switches, the number of copies of the cell corresponding to a number of partial products in the multiplication, the copies of the cell being electrically connected in sequence.

6. The apparatus of claim 1,
wherein the resistive networks include a number of copies of a cell of resistors and switches, the number of copies of the cell corresponding to a number of partial products in the multiplication, the copies of the cell being electrically connected in sequence, the differential analog input supplied to the copies of the cells, different bits of the variable multi-bit digital input supplied to different copies of the cells, the different copies of the cells generating different partial products.

7. The apparatus of claim 1,
wherein the resistive networks include a number of copies of a cell of resistors and switches, the number of copies of the cell corresponding to a number of partial products in the multiplication, the copies of the cell being electrically connected in sequence, positions of the cell in the sequence corresponding to the varying weights of the partial products.

8. The apparatus of claim 1,
wherein the resistive networks include a number of copies of a cell of resistors and switches, the number of copies of the cell corresponding to a number of partial products in the multiplication, the copies of the cell being electrically connected in sequence via a particular resistance in the cell, the electrically connected sequence of cells terminated with twice the particular resistance in the cell.

9. The apparatus of claim 1, further comprising:
sample and hold circuitry providing finite impulse response filter inputs as the differential analog inputs to the plurality of multiplier circuits.

10. The apparatus of claim 1, further comprising:
sample and hold circuitry providing digital sampling mixer inputs as the differential analog inputs to the plurality of multiplier circuits.

11. An apparatus, comprising:
a plurality of multiplier circuits generating a differential analog product output by performing multiplication of a differential analog input and a fixed multi-bit digital input, multiplier circuits of the plurality of multiplier circuits comprising:
a resistive network sufficient to (i) generate partial products by performing multiplication of the differential analog input with different bits of the fixed multi-bit digital input and (ii) combine the partial products according to varying weights of the different bits of the fixed multi-bit digital input,
wherein the differential analog product outputs from the plurality of multiplier circuits are summed, by parallel electrical connection of the differential analog product outputs.

12. The apparatus of claim 11, wherein the fixed multi-bit digital inputs of the plurality of multiplier circuits are fixed interconnections of resistors.

13. The apparatus of claim 11,
wherein the differential analog product outputs from the plurality of multiplier circuits include first analog product outputs and second analog product outputs, the differential analog product outputs being the differences between the first analog product outputs and the second analog product outputs,
wherein the resistive networks in the plurality of multiplier circuits include first networks generating the first analog product outputs and second networks generating the second analog product outputs, the partial products are electrically coupled to the first networks or to the second networks according to the fixed multi-bit digital inputs of the plurality of multiplier circuits.

14. The apparatus of claim 11,
wherein the resistive networks include a number of copies of a cell of resistors, the number of copies of the cell corresponding to a number of partial products in the multiplication, the copies of the cell being electrically connected in sequence.

15. The apparatus of claim 11,
wherein the resistive networks include a number of copies of a cell of resistors, the number of copies of the cell corresponding to a number of partial products in the multiplication, the copies of the cell being electrically connected in sequence, the differential analog input supplied to the copies of the cells, different bits of the fixed multi-bit digital input supplied to different copies of the cells, the different copies of the cells generating different partial products.

16. The apparatus of claim 11,
wherein the resistive networks include a number of copies of a cell of resistors, the number of copies of the cell corresponding to a number of partial products in the multiplication, the copies of the cell being electrically connected in sequence, positions of the cell in the sequence corresponding to the varying weights of the partial products.

17. The apparatus of claim 11,
wherein the resistive networks include a number of copies of a cell of resistors, the number of copies of the cell corresponding to a number of partial products in the multiplication, the copies of the cell being electrically connected in sequence via a particular resistance in the cell, the electrically connected sequence of cells terminated with twice the particular resistance in the cell.

18. The apparatus of claim 11, further comprising:
sample and hold circuitry providing finite impulse response filter inputs as the differential analog inputs to the plurality of multiplier circuits.

19. The apparatus of claim 11, further comprising:
sample and hold circuitry providing digital sampling mixer inputs as the differential analog inputs to the plurality of multiplier circuits.

20. An apparatus, comprising:
a plurality of multiplier means for generating a differential analog product output by performing multiplication of a differential analog input and a multi-bit digital input, the multiplier means of the plurality of multiplier means comprising:
a resistive network means sufficient to (i) generate partial products by performing multiplication of the differential analog input with different bits of the multi-bit digital input and (ii) combine the partial products according to varying weights of the different bits of the multi-bit digital input,
wherein the differential analog product outputs from the plurality of multiplier means are summed, by parallel electrical connection of the differential analog product outputs.

21. An apparatus, comprising:
a plurality of multiplier circuits generating a single-ended analog product output by performing multiplication of a differential analog input and a variable multi-bit digital input, the multiplier circuits of the plurality of multiplier circuits comprising:
a resistive network sufficient to (i) generate partial products by performing multiplication of the differential analog input with different bits of the variable multi-bit digital input and (ii) combine the partial products according to varying weights of the different bits of the variable multi-bit digital input,
wherein the single-ended analog product outputs from the plurality of multiplier circuits are summed, by parallel electrical connection of the single-ended analog product outputs.

22. The apparatus of claim 21,
wherein the single-ended analog product outputs from the plurality of multiplier circuits include first analog product outputs, the single-ended analog product outputs being the first analog product outputs,
wherein the resistive networks in the plurality of multiplier circuits includes first networks generating the first analog product outputs, and
wherein the resistive networks of the plurality of multiplier circuits comprise:
sets of switches controlled by the multi-bit digital inputs with bits having a first value or a second value, the sets of switches generating the partial products corresponding to the bits having the first value by electrically coupling the differential analog inputs to the first networks generating the first analog product outputs.

23. The apparatus of claim 21,
wherein the single-ended analog product outputs from the plurality of multiplier circuits include first analog product outputs, the single-ended analog product outputs being the first analog product outputs,
wherein the resistive networks in the plurality of multiplier circuits includes first networks generating the first analog product outputs, and
wherein the resistive networks of the plurality of multiplier circuits comprise:
sets of switches controlled by the multi-bit digital inputs, wherein positions in the resistive networks of switches in the sets of switches result in the varying weights of the partial products.

24. The apparatus of claim 21,
wherein the single-ended analog product outputs from the plurality of multiplier circuits include first analog product outputs, the single-ended analog product outputs being the first analog product outputs,
wherein the resistive networks in the plurality of multiplier circuits includes first networks generating the first analog product outputs, and
wherein the resistive networks of the plurality of multiplier circuits comprise:
sets of switches controlled by the multi-bit digital inputs with bits having a first value or a second value, the sets of switches generating the partial products corresponding to the bits having the first value by electrically coupling the differential analog inputs to the first networks generating the first analog product outputs, and wherein positions in the resistive networks of switches in the sets of switches result in the varying weights of the partial products, and wherein the sets of switches are positioned between first parts of the resistive networks
corresponding to the partial products and second parts of the resistive networks
corresponding to the varying weights of the partial products.

25. The apparatus of claim 21,
wherein the resistive networks include a number of copies of a cell of resistors and switches, the number of copies of the cell corresponding to a number of partial products in the multiplication, the copies of the cell being electrically connected in sequence.

26. The apparatus of claim 21,
wherein the resistive networks include a number of copies of a cell of resistors and switches, the number of copies of the cell corresponding to a number of partial products in the multiplication, the copies of the cell being electrically connected in sequence, the differential analog input supplied to the copies of the cells, different bits of the variable multi-bit digital input supplied to different copies of the cells, the different copies of the cells generating different partial products.

27. The apparatus of claim 21,
wherein the resistive networks include a number of copies of a cell of resistors and switches, the number of copies of the cell corresponding to a number of partial products in the multiplication, the copies of the cell being electrically connected in sequence, positions of the cell in the sequence corresponding to the varying weights of the partial products.

28. The apparatus of claim 21,
wherein the resistive networks include a number of copies of a cell of resistors and switches, the number of copies of the cell corresponding to a number of partial products in the multiplication, the copies of the cell being electrically connected in sequence via a particular resistance in the cell, the electrically connected sequence of cells terminated with twice the particular resistance in the cell.

29. The apparatus of claim 21, further comprising:
sample and hold circuitry providing finite impulse response filter inputs as the differential analog inputs to the plurality of multiplier circuits.

30. The apparatus of claim 21, further comprising:
sample and hold circuitry providing digital sampling mixer inputs as the differential analog inputs to the plurality of multiplier circuits.

31. An apparatus, comprising:
a plurality of multiplier circuits generating a single-ended analog product output by performing multiplication of a differential analog input and a fixed multi-bit digital input, multiplier circuits of the plurality of multiplier circuits comprising:
a resistive network sufficient to (i) generate partial products by performing multiplication of the differential analog input with different bits of the fixed multi-bit digital input and (ii) combine the partial products according to varying weights of the different bits of the fixed multi-bit digital input,
wherein the single-ended analog product outputs from the plurality of multiplier circuits are summed, by parallel electrical connection of the single-ended analog product outputs.

32. The apparatus of claim 31, wherein the fixed multi-bit digital inputs of the plurality of multiplier circuits are fixed interconnections of resistors.

33. The apparatus of claim 31,
wherein the single-ended analog product outputs from the plurality of multiplier circuits include first analog product outputs, the single-ended analog product outputs being the first analog product outputs,
wherein the resistive networks in the plurality of multiplier circuits include first networks generating the first analog product outputs, the partial products corresponding to bits of the fixed multi-bit digital input having a first value being electrically coupled to the first networks.

34. The apparatus of claim 31,
wherein the resistive networks include a number of copies of a cell of resistors, the number of copies of the cell corresponding to a number of partial products in the multiplication corresponding to bits of the fixed multi-bit digital input having a first value, the copies of the cell being electrically connected in sequence.

35. The apparatus of claim 31,
wherein the resistive networks include a number of copies of a cell of resistors, the number of copies of the cell corresponding to a number of partial products in the multiplication corresponding to bits of the fixed multi-bit digital input having a first value, the copies of the cell being electrically connected in sequence, the differential analog input supplied to the copies of the cells, different bits of the fixed multi-bit digital input supplied to different copies of the cells, the different copies of the cells generating different partial products.

36. The apparatus of claim 31,
wherein the resistive networks include a number of copies of a cell of resistors, the number of copies of the cell corresponding to a number of partial products in the multiplication corresponding to bits of the fixed multi-bit digital input having a first value, the copies of the cell being electrically connected in sequence, positions of the cell in the sequence corresponding to the varying weights of the partial products.

37. The apparatus of claim 31,
wherein the resistive networks include a number of copies of a cell of resistors, the number of copies of the cell corresponding to a number of partial products in the multiplication corresponding to bits of the fixed multi-bit digital input having a first value, the copies of the cell being electrically connected in sequence via a particular resistance in the cell, the electrically connected sequence of cells terminated with twice the particular resistance in the cell.

38. The apparatus of claim 31, further comprising:
sample and hold circuitry providing finite impulse response filter inputs as the differential analog inputs to the plurality of multiplier circuits.

39. The apparatus of claim 31, further comprising:
sample and hold circuitry providing digital sampling mixer inputs as the differential analog inputs to the plurality of multiplier circuits.

40. An apparatus, comprising:
a plurality of multiplier means for generating a single-ended analog product output by performing multiplication of a differential analog input and a multi-bit digital input, the multiplier means of the plurality of multiplier means comprising:
a resistive network means sufficient to (i) generate partial products by performing multiplication of the differential analog input with different bits of the multi-bit digital input and (ii) combine the partial products according to varying weights of the different bits of the multi-bit digital input,
wherein the single-ended analog product outputs from the plurality of multiplier means are summed, by parallel electrical connection of the single-ended analog product outputs.
